(19) United States
(12) Patent Application Publication
(10) Pub. No.: US 2013/0063498 A1
(43) Pub. Date: Mar. 14, 2013

(54) DISPLAY APPARATUS

(71) Applicant: Tsuyoshi Yabukane, Mobara-shi (JP)

(72) Inventor: Tsuyoshi Yabukane, Mobara-shi (JP)

(73) Assignee: CANON KABUSHIKI KAISHA, Tokyo (JP)

(21) Appl. No.: 13/598,943

(22) Filed: Aug. 30, 2012

(30) Foreign Application Priority Data
Sep. 12, 2011 (JP) 2011-198162

(51) Int. Cl. G09G 3/30

(52) U.S. Cl. 345/690; 345/77

(57) ABSTRACT

A display apparatus includes: a plurality of light emitting elements to display an image; a plurality of pixel circuits including a drive transistor configured to generate a current supplied to each of the light emitting elements, a capacitor having one terminal connected to a gate of the drive transistor, and a reset transistor connected between the gate and a drain of the drive transistor; and a display image determination unit configured to determine a brightness of the image from image data. The reset transistor is brought into a conductive state in a reset period while a voltage of a terminal of the capacitor opposite to the terminal connected to the gate of the drive transistor is set to a data voltage. A length of the reset period is determined according to determination of the display image determination unit. An embodiment of the present invention is the pixel circuit for driving the display apparatus.

### BACKGROUND OF THE INVENTION

1. Field of the invention

The present invention relates to a display apparatus. In particular, the present invention relates to a display apparatus including a light emitting element such as an organic EL element.

2. Description of the related art

An organic EL display apparatus including an organic electroluminescence element (hereinafter, described as an organic EL element) has been known as the next-generation display apparatus. The organic EL element is configured of an anode, a cathode, and a light emitting layer including an organic compound sandwiched between the anode and the cathode. When a voltage is applied between the anode and the cathode, electrons are injected into the light emitting layer from the cathode, and positive holes (holes) are injected into the light emitting layer from the anode. The electrons and the positive holes recombine in the light emitting layer. The organic EL element emits light by energy generated by the recombination.

Examples of the drive system of the organic EL display apparatus include a voltage drive system and a current drive system. The voltage drive system controls a voltage applied to the organic EL element to emit light or no light. Because a relation between the voltage and a luminance is nonlinear, it is difficult to emit light at an intermediate luminance. Therefore, a light emitting element is set to two states of on and off, and gradation is expressed by a light emitting period or a light emitting area. On the other hand, the current drive system controls a current flowing through the organic EL element to emit light. Because the luminance of the organic EL element is mostly proportional to the current, an intermediate luminance can be obtained by analogously controlling the current.

In the current drive system in which the light emitting of the organic EL element is controlled by a drive transistor, the drive transistor is used to adjust light emitting intensity. The current drive system is influenced by a threshold voltage (hereinafter, referred to as Vth) variation of the drive transistor, and the current flowing through the organic EL element varies. Therefore, roughness appears on a display screen, which reduces image quality. Methods for resetting the threshold voltage variation include a drive method described in U.S. 2006/0077195 A1 which uses a pixel circuit.

The drain current Id of the drive transistor in a saturated region is expressed as follows:

Id=β*(Vgs−Vth)²

β=0.5*(βC*(W/L))

μ is carrier mobility; C is a channel capacity; W is a channel width; L is a channel length; Vgs is a gate-source voltage; and Vth is a threshold voltage.

In addition to the threshold voltage variation, a β variation exists as the variation of the drain current Id of the drive transistor. Although the pixel circuit described in the above literature deals with the Vth variation of the drive transistor, the pixel circuit does not deal with the β variation. Therefore, the current flowing through the organic EL element varies for every pixel.

### SUMMARY OF THE INVENTION

An aspect of the present invention is a pixel circuit for driving a display apparatus . According to an aspect of the present invention, a display apparatus includes: a plurality of light emitting elements arranged on a display area to display an image; a plurality of pixel circuits provided individually in each of the plurality of light emitting elements to supply a current to each of the light emitting elements; a data line drive circuit configured to supply a data voltage to the pixel circuit through a data line; a control line drive circuit configured to supply a control signal to the pixel circuit through a control signal line; and a display image determination unit configured to determine a brightness of the image displayed on the display area, from image data. The pixel circuit includes: a drive transistor configured to generate the current supplied to each of the light emitting elements; a capacitor having one terminal connected to a gate of the drive transistor; and a reset transistor connected between the gate and a drain of the drive transistor. The control line drive circuit supplies a control signal for conducting the reset transistor, to the pixel circuit in a state where a voltage of the other terminal of the capacitor opposite to the terminal connected to the gate of the drive transistor is set to the data voltage, and changes a length of a period during which the reset transistor is conducted according to determination of the display image determination unit.

The period during which the reset transistor is conducted is changed according to the brightness of the image, and thereby a data voltage range where the β variation is increased is changed. Consequently, the influence of the β variation can be reduced when viewed as the whole image.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a display apparatus of an exemplary embodiment of the present invention.

FIG. 2 is a diagram illustrating a circuit configuration of a pixel.

FIG. 3 is a timing chart of a pixel circuit.

FIG. 4 is a diagram illustrating changes of a drain current and a gate-source voltage with time.

FIG. 5 is a diagram illustrating a condition where an uneven width of a current caused by a β variation of a drive transistor is changed according to the length of a reset period.

FIG. 6 is a diagram illustrating a modulation range of a data voltage and a current.

FIG. 7 is a diagram illustrating a configuration of a data processing unit of a first exemplary embodiment.

FIG. 8 is a diagram illustrating a configuration of a digital-analog conversion unit.

FIG. 9 is a diagram illustrating a relation between data and a reference voltage.

FIG. 10 is a diagram illustrating a configuration of a data processing unit of a second exemplary embodiment.

FIG. 11 is a diagram illustrating a relation between a data voltage and a reference voltage in three cases with different reset periods.

FIG. 12 is a diagram illustrating a configuration of a data processing unit of a third exemplary embodiment.

FIG. 13 is a diagram illustrating a relation between digital gradation data and a drain current Id.

### DESCRIPTION OF THE EMBODIMENTS

Various exemplary embodiments, features, and aspects of the invention will be described in detail below with reference to the drawings.

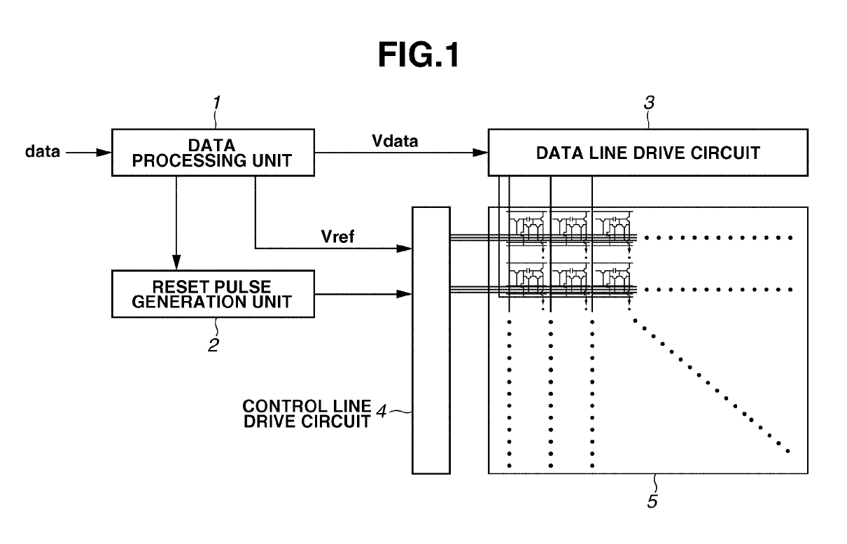

FIG. 1 is a block diagram illustrating a configuration of a display apparatus of an exemplary embodiment of the present invention. A plurality of light emitting elements and a plurality of pixel circuits configured to supply a drive current to the light emitting elements individually are arranged in a matrix to forma display area in a display unit 5. A data line drive circuit 3 and a control line drive circuit 4 are arranged around the display unit 5. A data voltage Vdata and a reference voltage Vref are supplied to the data line drive circuit 3 from a data processing unit 1. A reset signal is supplied to the control line drive circuit 4 from a reset pulse generation unit 2. Signals for timing control (not illustrated) are input to the control line drive circuit 4. Three control signals and the reference voltage Vref are supplied to the display unit 5.

Hereinafter, an organic EL element is described as an example of the light emitting element. However, exemplary embodiments of the present invention can also be applied to light emitting elements such as inorganic EL element, an LED, and a field emission element.

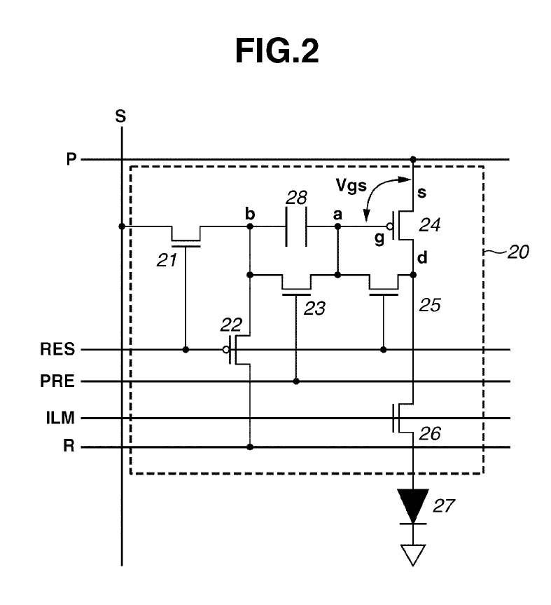

FIG. 2 illustrates a circuit configuration of the organic EL element and the pixel circuit. In the display unit 5 of an organic EL display apparatus, an organic EL element 27 and a pixel circuit 20 configured to drive the organic EL element 27 constitute one pixel. A plurality of pixels is arranged in a matrix to constitute a display area.

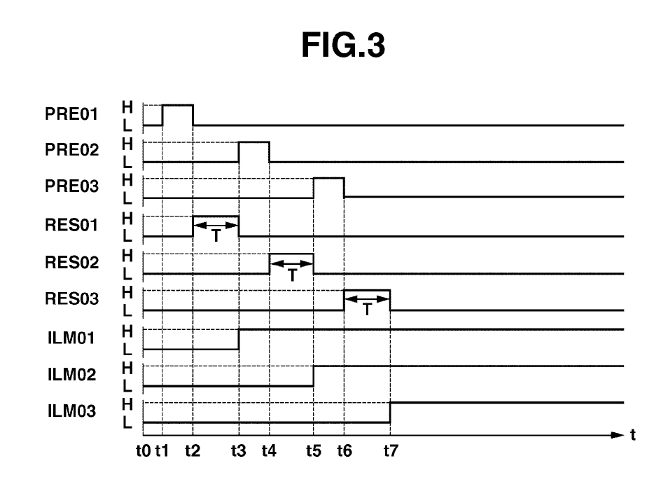

The pixel circuit 20 of FIG. 2 is characterized in that a transistor (reset transistor 25) is provided, which is a switch configured to cause short circuit between a gate and a drain of a drive transistor 24. The pixel circuit 20 operates according to a timing chart illustrated in FIG. 3.

The pixel circuit 20 is designed to compensate a pixel-to-pixel variation of a threshold voltage of the drive transistor 24. A drain current Id of the drive transistor 24 does not flow into the organic EL element 27, but flows through the reset transistor 25 and a capacitor 28 to a data line S for a period (a period represented by T in FIG. 3) that the reset transistor 25 is conducted by a signal of a reset signal line RES. Hereinafter, the period is referred to as a reset period. The current is transitional, and is gradually reduced as the charge of the capacitor 28 increases. At the same time, a gate-source voltage Vgs approximates the threshold voltage. When the period T is sufficiently secured, the gate-source voltage Vgs becomes almost equal to the threshold voltage Vth of the drive transistor 24.

After the gate-source voltage Vgs becomes almost equal to the threshold voltage Vth, the reset transistor 25 is turned off, and a voltage of a terminal opposite to a gate of the drive transistor 24 of the capacitor 28 is changed. In the pixel circuit of FIG. 2, the voltage change is a change from the data voltage Vdata of the data line S to the reference voltage Vref of a reference voltage line R. The voltage change fluctuates a gate voltage of the drive transistor 24 through the capacitor 28. The gate-source voltage Vgs is the threshold voltage with the voltage change added. Because the current generated by the drive transistor 24 is determined by the difference between the gate-source voltage Vgs and the threshold voltage, the drive transistor 24 generates a current depending on only β and the data voltage Vdata without depending on the threshold voltage. This is a compensation principle of a threshold voltage variation.

The pixel circuit of FIG. 2 is one example of circuits configured to compensate the variation of the threshold voltage. In addition, some circuits are presently discussed, which compensate the variation of the threshold voltage according to the same principle. These circuits are commonly characterized by an operation of feeding the drain current Id of the drive transistor 24 through the reset transistor 25 to the capacitor 28 (hereinafter, the operation is referred to as reset of a threshold voltage) . Exemplary embodiments of the present invention may be applied to all the pixel circuits configured to perform this operation.

Because the current generated by the drive transistor 24 varies when β has a variation even if the variation of the threshold voltage is compensated, the light emitting luminance of the organic EL element 27 also has a variation. β is proportional to the magnitude of the current. Therefore, the greater the current, the greater the width of the variation. More specifically, the greater a change in the gate-source voltage Vgs after the reset of the threshold voltage, the greater the width of the variation.

The magnitude of the change depends on the data voltage Vdata, and is equal to Vdata−Vref. Because the gate-source voltage Vgs is still the threshold voltage Vth when the change is 0, the current of the drive transistor 24 is also 0. This is equivalent to black display. The change in the gate-source voltage Vgs depending on the data voltage Vdata becomes the greatest in white display. At this time, the current of the drive transistor 24 is also the greatest. As the display becomes closer to the white display, the luminance variation caused by the variation of β is increased in a case where the threshold voltage variation is compensated.

When the length T of the reset period is shortened, the gate-source voltage Vgs of the drive transistor 24 at the end of the reset period becomes greater than the threshold voltage. It is necessary to adjust a modulation range of the data voltage Vdata so that the generation current of the drive transistor 24 is not changed when the length T of the reset period is shortened. More specifically, around the gate-source voltage Vgs (this is greater than the threshold voltage) of the drive transistor 24 at the end of the reset period, the gate-source voltage Vgs of the drive transistor 24 ranges in both a direction (the gate-source voltage Vgs is brought close to the threshold voltage, in other words, is brought close to the black display) in which the gate-source voltage Vgs becomes still smaller than the gate-source voltage Vgs at the end of the reset period, and a direction in which the gate-source voltage Vgs becomes greater than the gate-source voltage Vgs at the end of the reset period (the gate-source voltage Vgs is kept away from the threshold voltage, in other words, is brought close to the white display).

The current variation caused by β near the white display becomes smaller when the length T of the reset period is shortened compared with when the reset period is infinitely great. On the other hand, the current variation caused by β occurs also near the black display. The current variation caused by β is the smallest at an intermediate luminance, i.e., when the gate-source voltage Vgs of the drive transistor 24 after superposition of the data voltage Vdata becomes equal to the gate-source voltage Vgs at the end of the reset period. The luminance having the smallest current variation caused by β can be optionally changed to a high luminance side from a low luminance side by adjusting the length of the reset period.

An embodiment of the present invention may adjust the length of the reset period according to an average luminance of a display screen.

When the whole display screen has a low luminance, the reset period T is set to be comparatively long. Thereby, the current variation caused by β becomes the smallest near the average luminance. A high luminance pixel is greatly influenced by the variation of β, and is varied. However, because the number of the high luminance pixels is small, the high luminance pixels do not have a significant effect on the quality of the whole screen.

Conversely, when the whole display screen has a high luminance, the reset period T is set to be comparatively short. As a result, the gate-source voltage Vgs at the end of the reset period shows a value greatly apart from the threshold value. Current unevenness caused by the β variation is minimized near a current corresponding to the value, i.e., near a high luminance closer to the white display. The pixel on the low luminance screen is greatly influenced by the variation of β, and the luminance of the pixel varies. However, because the number of the pixels on the low luminance screen is few, the pixels have an insignificant effect on the quality of the whole screen.

Hereinafter, the principle of threshold voltage compensation will be described, and then the influence of the β variation when the length of the reset period T is adjusted will be described.

First, the operation of the pixel circuit 20 provided with a function to compensate the threshold voltage variation will be described in detail with reference to FIGS. 2 and 3.

The operation of the pixel circuit 20 is controlled by three control signals RES, PRE, and ILM. These are generated by the control line drive circuit 4, and are transmitted to the pixel circuit by respective control signal lines.

The pixel circuit 20 is connected to the data line S, a power source line P, and the reference voltage line R.

In the pixel circuit 20, a source s of the drive transistor 24 is connected to a power-supply voltage line P, and a gate g is connected to one terminal (referred to as an anode a) of the capacitor 28. The other terminal (referred to as an anode b) of the capacitor 28 is connected to the data line S via a data input transistor 21, or is connected to the reference voltage line R via a reference voltage input transistor 22. The reset transistor 25 is provided between the gate g and a drain d of the drive transistor 24. A precharge transistor 23 is provided between both terminals of the capacitor 28. The drain d of the drive transistor 24 is connected to an anode of the organic EL element 27 via a light-emission control transistor 26.

A gate of the reset transistor 25 is connected to the reset signal line RES, and is conducted (on) or nonconducted (off) by a reset signal RES (hereinafter, a control line configured to transmit the control signal and a signal transmitted by the control line are represented by the same reference numeral). Both the data input transistor 21 and the reference voltage input transistor 22 are complementary transistors. The gates of the data input transistor 21 and the reference voltage input transistor 22 are connected to the reset signal line RES. A gate of the precharge transistor 23 is connected to a precharge signal line PRE. A gate of the light-emission control transistor 26 is connected to a light emitting signal line ILM.

The signal lines configured to transmit the precharge signal PRE, the reset signal RES, and the light emitting signal ILM, and the two voltage lines (the power-supply voltage line P and the reference voltage line R) are common to the pixel circuit 20 arranged in a line direction. The data line S is common to the pixel circuit 20 arranged in a column direction.

FIG. 3 is a timing chart of each control signal. Numeral characters 01, 02, 03, . . . attached to the backs of reference numerals respectively illustrate control line inputs of the first, second, third . . . pixels. For example, PRE02 is the second precharge signal.

Because the first reset signal RES01 is at a low level from time t0 to time t1, the reference voltage input transistor 22 which is a P type transistor is turned on. The data input transistor 21 and the reset transistor 25 which are N type transistors are turned off. As a result, the data line side terminal (node b) of the capacitor 28 is connected to the reference voltage line R. The reference voltage Vref is supplied to the reference voltage line R.

When the first precharge signal PRE01 is set to a high level at the time t1, the precharge transistor 23 is turned on, and both terminals of the capacitor 28 are short-circuited. The gate g side terminal (node a) of the capacitor 28 is also set to the reference voltage Vref. The reference voltage Vref is set to be sufficiently lower than a voltage Voled (hereinafter, referred to as a power-supply voltage) of the power-supply voltage line R. Thereby, the gate-source voltage Vgs of the drive transistor 24 becomes greater than the threshold voltage Vth, and the drive transistor 24 is brought into a conductive state.

When the precharge signal PRE01 is set to a low level and the reset signal RES01 is set to a high level at time t2, the data input transistor 21 and the reset transistor 25 are turned on, and the reference voltage input transistor 22 and the precharge transistor 23 are turned off. The node b is set to the data voltage Vdata of the data line S.

Because the drive transistor 24 is brought into a conductive state, the drain current Id flows. The current supplies a positive charge to the gate g side terminal (node a) of the capacitor 28 through the reset transistor. Accordingly, the potential of the node a rises, and the gate-source voltage Vgs of the drive transistor 24 decreases. Finally, when the gate-source voltage Vgs is substantially equal to the threshold voltage Vth, the drain current Id of the drive transistor 24 hardly flows. The voltage of the node a is substantially equal to Voled−Vth, and is stabilized. Because the data voltage Vdata is applied to the node b during the conduction period of the reset transistor 25, a voltage Vdata−(Voled−Vth) is generated between the electrodes of the capacitor 28.

An operation for bringing the gate-source voltage Vgs of the drive transistor 24 close to the threshold voltage Vth from the time t2 to time t3 is referred to as threshold voltage (Vth) reset. As time T=t3−t2 of the Vth reset is lengthened, the gate-source voltage Vgs is brought closer to the threshold voltage Vth.

After a reset period is ended at the time t3, the reset signal RES01 is set to a low level. Because the reset transistor 25 is turned off after the end of the reset period, the charge of the capacitor 28 is not changed. A voltage between both terminals is stored as it is as Vdata−(Voled−Vth). Because the data input transistor 21 is turned off, and the reference voltage input transistor 22 is turned on, the node b is set to the reference voltage Vref again. The potential of the node a is Vref−{Vdata−(Voled−Vth)}. The gate-source voltage Vgs of the drive transistor 24 is

Vgs=Voled−[Vref−{(Vdata−(Voled−Vth)}]=Vdata+Vth−Vref

Thus, the drain current Id independent of a threshold flows through the drive transistor 24. More specifically, the pixel circuit 20 is provided with a function of resetting the threshold voltage variation.

When light emitting pulse input ILM01 is set to a high level, the drain current Id according to the gate-source voltage Vgs of the drive transistor 24 flows through the organic EL element 27, and the organic EL element 27 emits light. Although the light emitting pulse input ILM01 is set to a high level simultaneously with the end of the reset period at the time t3 in the timing chart of FIG. 3, the timing may be optionally set after the end of the reset period.

Although not illustrated in FIG. 3, when the light emitting pulse input ILM01 is set to a low level after the lapse of a certain light emitting period, the supply of the drain current Id to the organic EL element 27 is stopped, and the organic EL element 27 is turned off. The timing can also be optionally set.

The same operation is performed also for the second and subsequent pixels.

In the circuit of FIG. 2, after the end of the Vth reset, a terminal (node b) opposite to the drive transistor 24 of the capacitor 28 is switched to the reference voltage line R from the data line S by the data input transistor 21 and the reference voltage input transistor 22. A similar effect can be achieved when the voltage of the data line S is switched to the reference voltage Vref from Vdata instead of the reference voltage line R. At the time of the Vth reset, the node b may be connected to the reference voltage line R, and may be then switched to the data line S. In this case, it is necessary to reverse a relationship between the reference voltage Vref and the data voltage Vdata.

Next, the influence of the β variation when the reset period T is changed will be described.

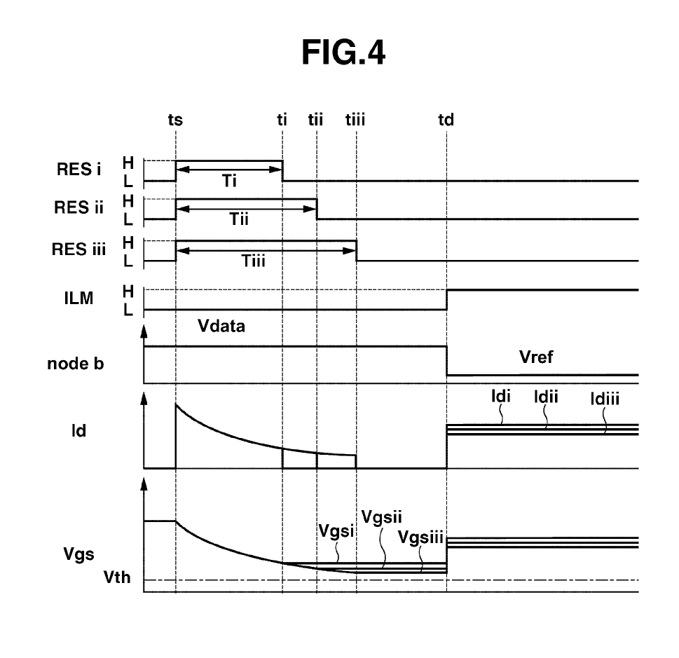

FIG. 4 is a diagram illustrating conditions of a drain current Id and the gate-source voltage Vgs of the drive transistor 24 when the reset period shows three kinds of Ti, Tii, and Tiii (Ti<Tii<Tiii).

When an RES signal is set to an H level at time ts, and the reset period is started, the drain current Id of the drive transistor 24 flows through the reset transistor 25 to charge the capacitor 28. The voltage of the node a rises gradually, and along with it, the drain current Id decreases. When the reset period is ended at the times ti, tii, or tiii, the drain current Id does not flow, and the voltage of the node a is held at a voltage shown at the end of the reset. The shorter the reset period, the lower the voltage of the node a. Therefore, with respect to the gate-source voltage Vgs, the Vgsi is the greatest in the case of T=Ti, and the Vgsiii is the smallest in the case of T=Tiii.

When the node b is switched to Vref from Vdata at time td after the reset period is ended, the gate-source voltage Vgs is the voltage at the end of the reset period to which a switching change is added. The drain current Id according to the voltage flows through the organic EL element 27 from the drive transistor 24. Because the current depends on the gate-source voltage Vgs, Idi in the case of T=Ti is the greatest, and Idiii in the case of T=Tiii is the smallest.

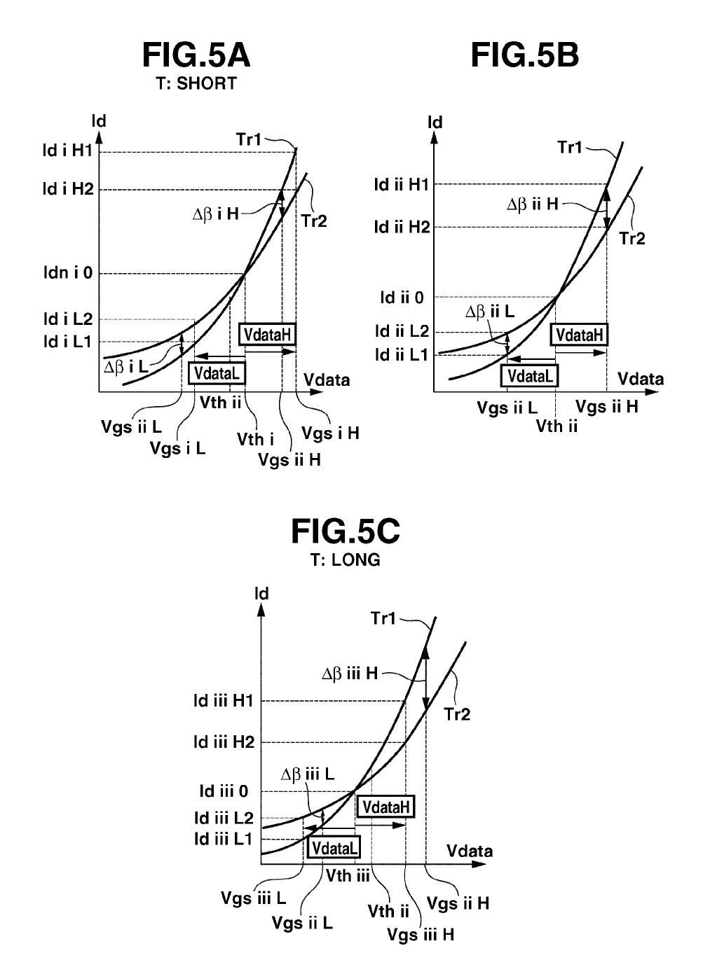

FIGS. 5A to 5C illustrate a relation between the data voltage Vdata supplied to the data line S after the Vth reset of the drive transistor 24 and the current Id supplied to the EL from the drive transistor 24. A horizontal axis represents the data voltage Vdata and a vertical axis represents the current Id. FIGS. 5A to 5C illustrate three kinds of the reset period T. FIG. 5A illustrates a case where the reset period T is short. FIG. 5B illustrates a case where the reset period T is intermediate. FIG. 5C illustrates a case where the reset period T is long.

Two curves illustrate the difference according to β of the drive transistor 24. In FIG. 5, an intersection (Vgs at the end of the operation of the Vth reset) of a transistor 1 with a transistor 2 is referred to as a Vth reset point.

As described above, as the Vth reset is performed for a longer period, the gate-source voltage Vgs is brought closer to the threshold voltage Vth (Id=0). For example, in a VGA display (640 columns* 480 lines) of 60 Hz in one frame, a writing period for one line is 34.7 μs or less. Depending on the size of the capacitor 28, the gate-source voltage Vgs can be reset such that the Vth reset period T is 5 μs or more and the error of the drain current Id is about 1% or less.

FIG. 5B is defined as the reference of the Vth reset period T. In the Vth reset point of FIG. 5B, the drain currents Id1 and Id2 of the transistor 1 and the transistor 2 are set such that Id1=Id2=Idii0, and the gate-source voltages Vgs1 and Vgs2 thereof are set such that Vgs1=Vgs2=Vthii. Hereinafter, the drain current Id at the Vth reset point is referred to as a Vth reset current. When the data voltage Vdata corresponding to the Vth reset current Idii0 is input into a Vdata line S, the drain current Id of the drive transistor 24 having the different characteristics as described above is set to Idii0, and the error is 0. On the other hand, because β is different under a condition where the data voltage Vdata input into the Vdata line S generates a current of Idiio or less and Idii or more, an error is generated in the drain current Id even when the Vth reset operation is performed. The error becomes greater as it departs further away from the Vth reset point.

As the Vth reset period T becomes longer as it shifts from FIG. 5A to 5C as described above, the drain current Id of the drive transistor 24 at the Vth reset point becomes smaller. As illustrated in FIGS. 5A to 5C, the Vth reset current Idii0 can be set by setting the Vth reset period T.

Because the reset period T in FIG. 5A is shorter than that in FIG. 5B, and the Vth reset current is set to a greater value, the drain current Id when light is emitted becomes greater, and the influence of Δβ which is the β variation can be reduced in a higher current region. More specifically, the Vth reset current Idii0 is set such that Idii0<Idi0; the drain current Id when light is emitted is set such that IdiiH1<IdiH1 and IdiiH2<IdiH2; and the β variation is set such that ΔβiH <ΔβiiH and ΔβiL>ΔβiiL.

Because the reset period T in FIG. 5C is longer than that in FIG. 5B, and the Vth reset current Idii0 is set to a smaller value, the drain current Id when light is emitted becomes smaller, and the influence of the β variation, Δβ, can be reduced in a small current region. More specifically, the Vth reset current Idii0 is set such that Idii0>Idiii0; the drain current Id when light is emitted is set such that IdiiH1 >IdiiiH1 and IdiiH2>IdiiiH2; and the β variation is set such that ΔβiiiH>ΔβiiH and ΔβiiiL<ΔβiiL.

Accordingly, the reset period T is shortened when the average value of the data is great, i.e., in a bright display image, whereas the reset period T is lengthened when the average value of the data is small, i.e. , in a dark display image, and thereby the β variation, Δβ, can be reduced.

The reset period becomes the shortest when the display screen displays the greatest luminance in all the pixels. The reset period when the average luminance is Iav is determined to coincide with the gate-source voltage Vgs when the gate-source voltage Vgs at the end of the reset period displays the luminance Iav in the attenuation curve of the gate-source voltage Vgs starting from time is of FIG. 4. A relation between the luminance Iav and the reset period may be previously measured, and may be written in a look-up table. The reset period may be set with reference to the relation in the case of the actual image display.

The brightness of a display image is determined by an total brightness of the organic EL elements in the display area. The brightness of a display image can be determined by calculating input data in an display image determination unit. One of the calculation methods is obtaining an average value of input data in one frame, determining the brightness of the display image by comparing the average value with the reference value, and controlling the Vth reset period T according to the determination. The display image may be determined using the average value of data converted into luminance information with consideration for γ characteristic in addition to the average value of the input data. The display image may be ranked not in two of light and darkness but in several stages, and the Vth reset period T according to the ranked display image may be set.

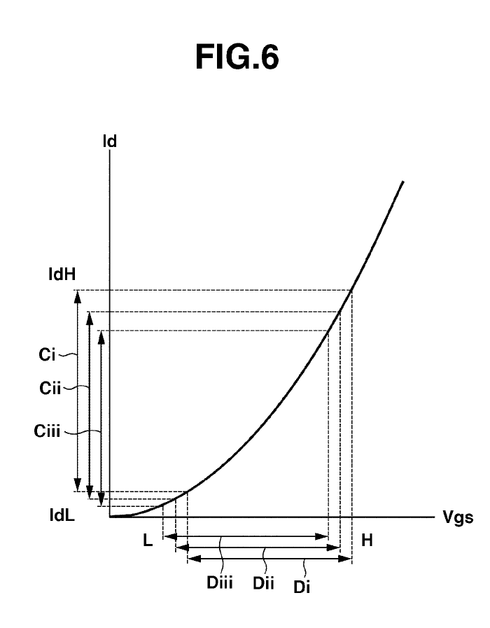

FIG. 6 illustrates a modulation range of a voltage and a current on a graph illustrating a relation between the gate-source voltage Vgs and the drain current Id of the drive transistor 24. The gate-source voltage Vgs is modulated in a range of a double-headed arrow represented by L and H of a horizontal axis, by the data voltage Vdata. Thereby, the drain current Id fluctuates in a range of IdL to IdH of a vertical axis.

The gate-source voltage Vgs after the end of the reset takes different values as indicated by Vgsi, Vgsii, and Vgsiii of FIG. 4 in cases where the reset period T is (i) short, (ii) intermediate, and (iii) long. Therefore, as the reset period becomes longer, the modulation range of the gate-source voltage by the data voltage Vdata is shifted to a low-voltage side, i.e., to Diii from Di. The modulation range of the drain current Id is also shifted to a low current side, i.e., to Ciii from Ci, and a fluctuation width thereof is reduced. This shows that the brightness and the contrast of the image are changed when the reset period is changed.

The overall brightness and contrast of the image are desirably unchanged even when the reset period is changed. For this purpose, the reference voltage Vref is changed according to the reset period so that the modulation range of a fixed drain current Id is obtained, and a modulation range D of the gate-source voltage Vgs is unchanged. The range of the data voltage Vdata may be changed instead of the reference voltage Vref. Examples of the method for changing the range of the data voltage Vdata include converting digital image data, or changing the upper limit voltage and the lower limit voltage of a circuit (DAC described below) configured to generate the data voltage Vdata.

Hereinafter, aspects of the present invention will be described with reference to exemplary embodiments.

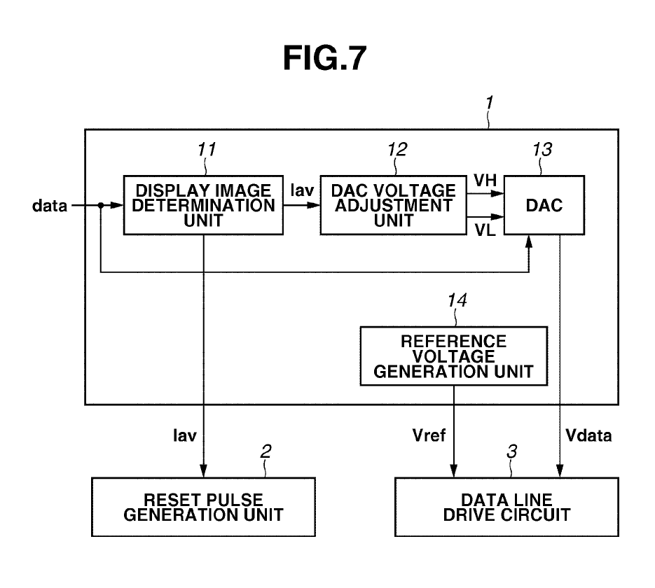

FIG. 7 is a block diagram illustrating the inside of a data processing unit 1 in a display apparatus of a first exemplary embodiment of the present invention. The data processing unit 1 includes a digital/analog converter (DAC) 13, and converts digital image data entering from the outside into an analog data voltage, Vdata.

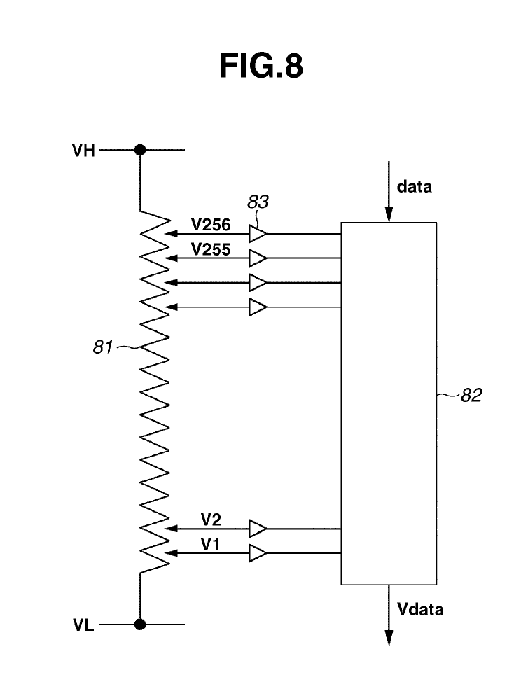

FIG. 8 illustrates an inner circuit of the DAC 13. A ladder resistor 81 is connected between an upper limit voltage VH and a lower limit voltage VL. Voltages V1 to V256 taken from 256 halfway branch points are input into an 8-bit decoder 82 through a buffer amplifier 83. The decoder 82 decodes 8-bit digital image data. One of the 256 voltages is selected, and is output as Vdata.

The data processing unit 1 includes a display image determination unit 11 configured to calculate an average luminance of a screen from the digital image data and to determine a brightness of a display image according to the value, a DAC voltage adjustment unit 12 configured to determine an upper limit and a lower limit (VH and VL) of an output voltage of the DAC, and a reference voltage generation unit 14 configured to generate a reference voltage Vref.

The display image determination unit 11 obtains an average luminance Iav by taking in the digital image data, and sends the average luminance Iav to the DAC voltage adjustment unit 12 and a reset pulse generation unit 2.

The reset pulse generation unit 2 generates a reset pulse having a pulse width T adjusted according to the average luminance Iav. The reset pulse generation unit 2 previously obtains the determined reference luminance and a reset period Tii corresponding to the reference luminance. The reset pulse generation unit 2 sets a reset period T to Ti which is shorter than Tii when the average luminance Iav is equal to or higher than a reference luminance I0. The reset pulse generation unit 2 sets the reset period T to Tiii which is longer than Tii when the average luminance Iav is lower than the reference luminance.

The generated reset pulse is input into a control line drive circuit 4, and is supplied to each pixel circuit as a reset signal RES with its timing delayed for every line.

The DAC voltage adjustment unit 12 adjusts VH and VL according to the average luminance Iav, and supplies the adjusted VH and VL to the DAC 13. An upper limit voltage of the DAC for the reference luminance I0 is set to VHii. A lower limit voltage of the DAC is set to VLii. When the average luminance Iav is higher than I0, the upper limit voltage VH is set to VHi which is lower than VHii, and the lower limit voltage VL is set to VLi which is lower than VLii. When the average luminance Iav is lower than I0, the upper limit voltage VH is set to VHiii which is higher than VHii, and the lower limit voltage VL is also set to VLiii which is higher than VL0.

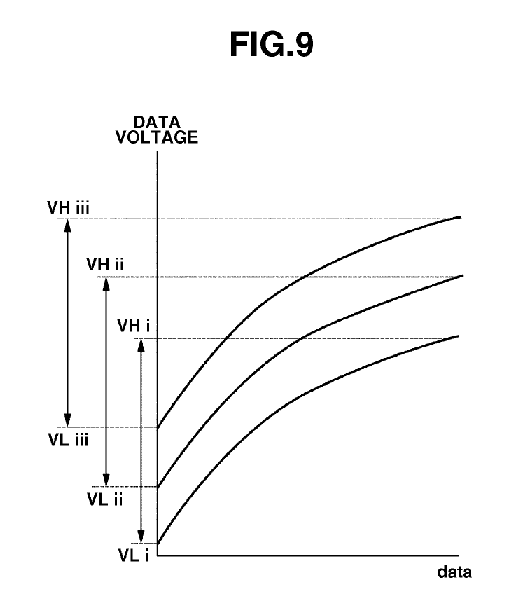

The DAC 13 generates a data voltage Vdata between the upper limit voltage VH and the lower limit voltage VL according to the data voltage data. In FIG. 9, a horizontal axis represents digital image data, and a vertical axis represents a data voltage Vdata generated by the DAC 13 when the luminance is I0, and the average luminance Iav is higher and lower than I0.

The generated data voltage Vdata is supplied to a data voltage line S of a pixel circuit 20 through a data line drive circuit 3.

The reference voltage generation unit 14 generates the reference voltage Vref. The generated reference voltage Vref is supplied to a reference voltage line R of the pixel circuit 20 via the data line drive circuit 3.

The unevenness of the luminance caused by β variation can be suppressed to be small without changing the brightness and the contrast of the display image, by changing the length T of the reset period and the range of the data voltage Vdata according to the present exemplary embodiment.

In the present exemplary embodiment, the brightness of the image is determined by the average luminance. However, indices other than the average luminance such as a gradation level (most frequent luminance) having the greatest appearance frequency over all the pixels may be used to determine the brightness. Further, the reset period is switched at two stages according to the brightness according to the present exemplary embodiment. However, the reset period may be switched at multistage of three or more, or the reset period may be sequentially changed.

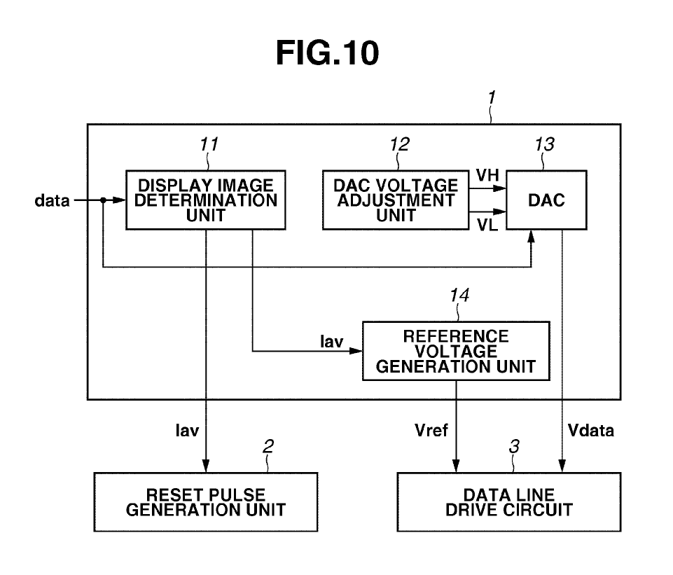

FIG. 10 is a block diagram illustrating a structure of a data processing unit of a second exemplary embodiment of the present invention. Portions similar to those of FIG. 7 are designated by the same reference numerals, and the repeated description is omitted.

The present exemplary embodiment is different from the first exemplary embodiment in that the output of a display image determination unit 11 is input into not a DAC voltage adjustment unit 12 but a reference voltage generation unit 14. More specifically, in the present exemplary embodiment, a reference voltage Vref is switched according to an average luminance.

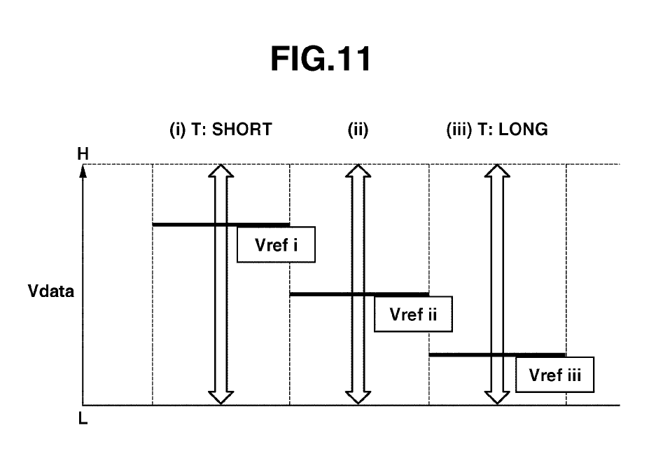

FIG. 11 illustrates a method for changing the reference voltage Vref according to switching of a reset period. (i), (ii), (iii) in FIG. 11 respectively represent cases where the reset period T is (i) short to (iii) long. Because a gate-source voltage Vgs immediately after the end of the reset period becomes high when the reset period T is shortened for the reference (ii), a reference voltage is set closer to VH (a data voltage Vdata of white display) by an amount of the high gate-source voltage Vgs. Conversely, because the gate-source voltage Vgs immediately after the end of the reset period is low when the reset period T is lengthened for the reference (ii), the reference voltage is set closer to VL (a data voltage Vdata of black display) by an amount of the low gate-source voltage Vgs. The data voltage Vdata is unchanged in both cases. Therefore, both the modulation range of the gate-source voltage Vgs and the change range of a drain current Id can be constantly maintained.

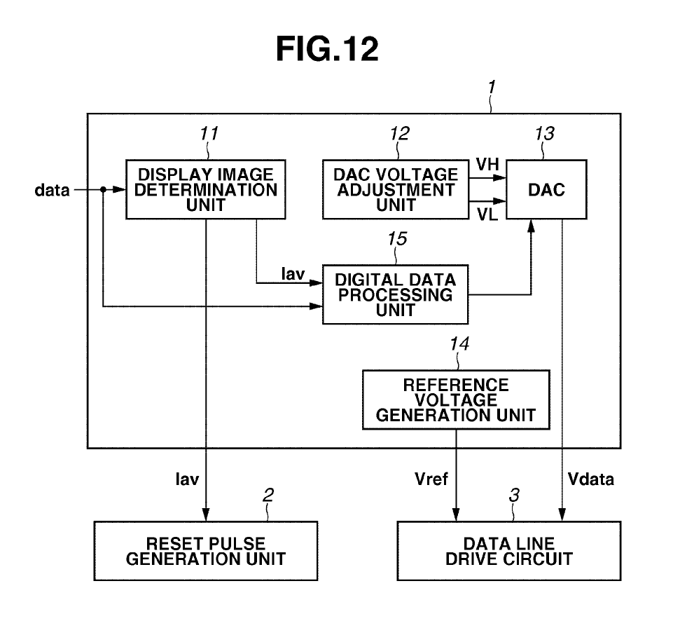

FIG. 12 illustrates a third exemplary embodiment of the present invention. Portions similar to those of FIG. 7 are designated by the same reference numerals, and the repeated description is omitted.

The present exemplary embodiment includes a digital data processing unit 15. The modulation range of a drain current Id is kept constant by changing the range of a digital image signal according to a change in a reset period.

When the reset period T is shortened for the reference (ii), a modulation range is enlarged when a drain current Id is high. The digital data processing unit 15 restricts the gradation (represented by a 8-bit digital signal) of the image signal to a range lower than 255 to eliminate the enlargement of the modulation range. More specifically, the high gradation side of the digital image signal is restricted by an amount of the drain current Id increased by shortening the reset period T. Therefore, the upper limit of the drain current Id is constantly maintained.

On the other hand, because a low current side modulation range is enlarged when the reset period T is lengthened for the reference (ii), low gradation side data is restricted. More specifically, a gradation order higher than 0 is defined as lowest gradation. As a result, the lower limit of the drain current Id can be invariably maintained.

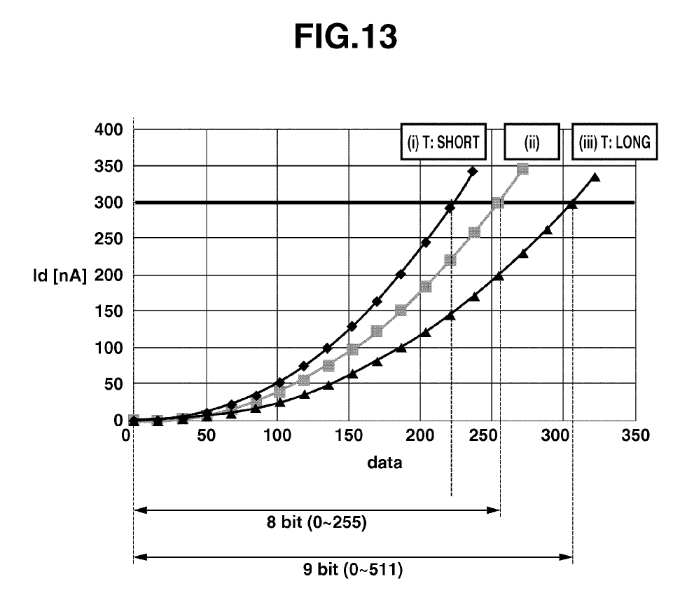

When the reset period T is lengthened, a high gradation side current also decreases, which reduces a luminance. A method for improving the reduction of the luminance will be described with reference to FIG. 13.

When the reset period T is lengthened, if data is not made greater for the reference (ii), the drain current Id decreases. In this case, if a DAC is provided with a 8-bit decoder, 0 to 255 are allocated to the data, so that the DAC cannot express all the data. Therefore, a DAC is used, which is provided with a 9-bit decoder configured to convert data of 0 to 511 to an analog voltage. FIG. 13 represents a relation between data and a drain current Id according to each reset period T, which is obtained using the following formula.

Id=Id0(x/255)^{γ}

Id0 is a drain current Id in data of 255; x is data; and γ is a gamma coefficient.

When 0 nA to 200 nA of the drain current Id flows through an EL element with γ 2.2 and data of 0 to 255 in the reference (ii), a drain current value of each data can be obtained as illustrated in (ii) of FIG. 13.

As described above, when the reset period T is changed to (iii) T: long from (i) T: short without changing the data, and a Vth reset point is changed, the drain current Id is changed. Based on the change, the drain current Id is defined as follows.

When 0 nA to 400 nA of the drain current Id flows into the EL element with γ of 2.2 and data of 0 to 255 in (i) T: short in the case of the same data as that of (ii), the drain current Id of each data can be obtained as illustrated in (i) of FIG. 13. When 0 nA to 200 nA of the drain current Id flows into the EL element with γ of 2.2 and data of 0 to 255 in (iii) T: long in the case of the same data as that of (ii), the drain current Id of each data can be obtained as illustrated in (iii) of FIG. 13.

As illustrated in FIG. 13, the greatest value of data is increased to 511 from 255 by changing the DAC to the 9-bit DAC from the 8-bit DAC, and a desired drain current Id can be obtained also when the reset period is lengthened. More specifically, the number of bits of the DAC can be increased by an amount of the drain current Id reduced by lengthening the reset period T and the range of data is widened, so that a desired drain current Id can be obtained.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-198162 filed Sep. 12, 2011, which is hereby incorporated by reference herein in its entirety.

1. A display apparatus including:
a plurality of light emitting elements arranged in a display area to display an image;
a plurality of pixel circuits provided individually in each of the plurality of light emitting elements to supply a current to each of the light emitting elements;
a data line drive circuit configured to supply a data voltage to the pixel circuit through a data line;
a control line drive circuit configured to supply a control signal to the pixel circuit through a control signal line; and
a display image determination unit configured to determine a brightness of the image displayed on the display area, from image data,
wherein the pixel circuit comprises:
a drive transistor configured to generate the current supplied to each of the light emitting elements;
a capacitor having one terminal connected to a gate of the drive transistor;
a reset transistor connected between the gate and a drain of the drive transistor; and
a light-emission control transistor connected between the drain of the drive transistor and the light emitting element; and
wherein the control line drive circuit supplies control signals for conducting the reset transistor and not conducting the light-emission control transistor to the pixel circuit while a voltage of other terminal of the capacitor opposite to the one terminal connected to the gate of the drive transistor is set to the data voltage, and changes a length of a reset period during which the reset transistor is conducted according to determination of the display image determination unit.

2. The display apparatus according to claim 1, wherein the display image determination unit determines the brightness of the image according to an average luminance of the image data.

3. The display apparatus according to claim 2, wherein the length of the reset period is changed to be short when the brightness of the image is high, and time to be long when the brightness of the image is low.

4. The display apparatus according to claim 1, wherein a modulation range of the data voltage is changed according to the length of the reset period.

5. The display apparatus according to claim 1, wherein the pixel circuit comprises a data input transistor and a reference-voltage input transistor connecting the other terminal of the capacitor to the data line and to a reference-voltage line configured to supply a reference voltage, respectively.

6. The display apparatus according to claim 1, wherein the control line drive circuit brings the data input transistor into a non-conductive state and the reference voltage input transistor into a conductive state after the reset period.

7. The display apparatus according to claim 5, wherein the reference voltage is changed according to the length of the reset period.

8. The display apparatus according to claim 1, wherein the pixel circuit comprises a precharge transistor connecting both terminals of the capacitor.

9. The display apparatus according to claim 8, wherein the control line drive circuit supplies a control signal for conducting the precharge transistor to the pixel circuit before the reset period.

10. A method for driving a display apparatus,
the display apparatus comprising:
a plurality of light emitting elements arranged in a display area to display an image;
a plurality of pixel circuits comprising a drive transistor configured to generate a current supplied to each of the light emitting elements, a capacitor having one terminal connected to a gate of the drive transistor, a reset transistor connected between the gate and a drain of the drive transistor, a light-emission control transistor connected between the drain of the drive transistor and the light emitting element, and a precharge transistor connecting both terminals of the capacitor;
a data line drive circuit configured to supply a data voltage to the pixel circuit through the data line;
a control line drive circuit configured to supply a control signal to the pixel circuit through the control signal line; and
a display image determination unit configured to determine a brightness of the image displayed on the display area, from image data,
the method comprising:
determining the brightness of the image displayed on the display area from the image data by a display image determination unit;
determining a length of a reset period according to the brightness determined by the display image determination unit;
during the reset period, bringing the light-emission control transistor into a nonconductive state and the reset transistor into a conductive state while a voltage of the other terminal of the capacitor opposite to the terminal connected to the gate of the drive transistor is set to the data voltage; and
after the reset period, bringing the light-emission control transistor into a conductive state while a voltage of the other terminal of the capacitor is set to a reference voltage.

11. The method according to claim 10, wherein a modulation range of the data voltage is changed according to the length of the reset period.

12. The method according to claim 10, wherein the reference voltage is changed according to the length of the reset period.

13. The method according to claim 10, further comprising conducting the precharge transistor before the reset period.

14. An apparatus including:
a plurality of pixel circuits to supply a current to a plurality of light emitting elements individually;
a data line drive circuit configured to supply a data voltage to the pixel circuit through the data line;
a control line drive circuit configured to supply a control signal to the pixel circuit through the control signal line; and
a display image determination unit configured to determine a brightness of an image from image data,
wherein the pixel circuit comprises:
a drive transistor that supplies the current to the light emitting element;
a capacitor having a first terminal connected to a gate of the drive transistor;
a reset transistor connected between the gate of the drive transistor and a drain of the drive transistor; and
a light control transistor connected between the drain of the drive transistor and the light emitting element; and
wherein the control line drive circuit supplies control signals for conducting the reset transistor and not conducting the light control transistor to the pixel circuit while a voltage of a second terminal of the capacitor opposite to the first terminal of the capacitor is set to the data voltage, and changes a length of a reset period during which the reset transistor is conducted according to the brightness of the image data determined by the display image determination unit.

15. A display apparatus including:
the apparatus according to claim 14; and
the plurality of light emitting elements.
